(19) United States
(12) Patent Application Publication
(10) Pub. No.: US 2007/0274722 A1
(43) Pub. Date: Nov. 29, 2007

(54) Method of Communicating for a Communication Apparatus

(75) Inventors: Jun Zhao, Shenzhen (CN); Peilong Tan, Shenzhen (CN); Tao Jiang, Shenzhen (CN); Feng Wang, Shenzhen (CN); Jun Chen, Shenzhen (CN); Yuntao Wang, Shenzhen (CN); Huafeng Lin, Shenzhen (CN); Guo Wei, Shenzhen (CN); Wei Huang, Shenzhen (CN)

Correspondence Address: CONLEY ROSE, P.C., 5601 GRANITE PARKWAY, SUITE 750, PLANO, TX, 75024, US

(73) Assignee: Huawei Technologies Co., Ltd., Shenzhen (CN)

(21) Appl. No.: 11/611,389

(22) Filed: Dec. 15, 2006

(30) Foreign Application Priority Data
May 29, 2006 (CN) 200610060873.7

(51) Int. Cl. H04J 14/00

(52) U.S. Cl. 398/71; 398/1

(57) ABSTRACT

A method of communicating for a communication apparatus, which includes: a terminal apparatus transmitting the information frames to a central office apparatus; the central office apparatus receiving the information frames and obtaining the terminal apparatus information from the information frames; the central office apparatus processing the information frames transmitted from the terminal apparatus, using the terminal apparatus information obtained from the information frames; whereby communication between the central office apparatus and the terminals of different vendors is implemented.

### CROSS-REFERENCE TO RELATED APPLICATIONS

This application is claiming priority of Chinese Application No. 200610060873.7 filed May 29, 2006, entitled “A Method of Communicating for a Communication Apparatus” which application is incorporated by reference herein in its entirety.

### BACKGROUND

The present disclosure relates to communication techniques, especially a method and a system of communication for a communication apparatus.

As shown in FIG. 1, a fiber access point-to-multi-point optic network includes a central office optical line terminal (OLT), at least one splitter, a plurality of remote apparatus optical network terminals (ONTs), and the associated fiber. The central office apparatus and optical splitters are connected together with the fiber, which forms the backbone of the optical network. The splitters are connected to each remote apparatus with a plurality of branching optical fibers.

In a passive optical network (PON), the transmission of data streams between the office-side OLT and the remote apparatus ONT is implemented by creating a schedule between the central office OLT and every terminal apparatus ONT. The central office OLT assigns bandwidth grants for upstream data to every terminal apparatus ONT according to the bandwidth requirements of every terminal apparatus. By granting bandwidth to every terminal apparatus ONT, the scheduling for upstream transmission traffic for the terminal apparatus ONT is achieved.

In order to guarantee the quality of service of the transmissions, the terminal apparatus ONTs need to classify the services according to their priorities and transmit each service with a reference to its priority. However, in an actual network application, an OLT connects to different vendors' terminal apparatus ONTs. Since there no standard for service classification in the terminals, different service classification methods are deployed in the different vendors' terminal apparatus when implementing the service classification. For example, in some vendors' terminals, the service classification is developed using a virtual local area network (VLAN) method, while other vendors implement the Institute of Electrical and Electronics Engineers (IEEE) 802.1p service classification method in their terminals. Even if the different vendor apparatuses adopted the same classification method, the classification method strategy would likely be different. For instance, “voice service=VLAN1” and “data service=VLAN2” are used in some vendors' terminal apparatus, while “voice service=VLAN5” and “data service=VLAN6” are used in other vendors' terminal apparatus. In such a case, the central office apparatus OLT should configure and process the different terminal apparatus using a common classification strategy so as to realize the communication between central office OLT and the different terminal apparatus. For terminal apparatus that adopt the VLAN service classification method, the central office apparatus configures their service using a common classification strategy. For example, “voice service” would be configured as VLAN1 and “data service” would be configured as VLAN2. For terminal apparatus which adopt the 802.1p service classification method, “voice service” would be configured as COS7 and “data service” would be configured as COS5. Whenever a new terminal apparatus is linked to the OLT or there are some changes to the terminal apparatuses that are linked to OLTs, the operators are required to reconfigure the terminal apparatuses. Thus, the work efficiency is very low and the manual configuration is prone to suffer errors.

### SUMMARY

An embodiment of the present disclosure provides a method and a system of communication for a communication apparatus to solve problems like low work efficiency or error-suffering configuration that occur when different terminals are linked to communication networks.

An embodiment of the present disclosure provides a method of communication for a communication apparatus, comprising following steps:

an optical network terminal (ONT) sending an information frame upstream to an optical line terminal (OLT); and

the OLT receiving the information frame, obtaining information about the ONT from the information frame and processing the information frame received from the ONT with the information about the ONT.

An embodiment of the present disclosure also provides a system of communication for a communication apparatus, which includes the central office apparatus and the terminal apparatus connected to the central office apparatus through the splitters, the system comprising:

An interconnected apparatus, the interconnected apparatus connected to the central office apparatus, the terminal apparatus information from the transmitted information frames are gathered by the interconnected apparatus; using the gathered terminal apparatus information configuration data table, the terminal information is stored in the data table; the information frames are received from the central office apparatus by the interconnected apparatus and the information frames transmitted by terminal apparatus are processed using the information frame processing method in the data table.

By receiving the transmitted information frames from the terminal apparatus, the central office apparatus automatically obtains the terminal apparatus information from the information frames; the central office apparatus configures the processing method for the terminal information automatically according to the terminal apparatus information, to thereby improving the data processing efficiency and correctness.

### BRIEF DESCRIPTION OF THE DRAWINGS

FIG. 1 is a component diagram of an embodiment of the PON.

FIG. 2 is the network composition diagram of an embodiment of the present disclosure.

FIG. 3 is the message time sequence for an embodiment of the present disclosure.

FIG. 4 is diagram illustrating an implementation of the different terminal service by the central office apparatus OLT for an embodiment of the present disclosure.

FIG. 5 is the service processing procedure diagram for an embodiment of the present disclosure.

### DETAILED DESCRIPTION

The embodiment of the present disclosure will be detailed described with reference to the following drawings.

### Embodiment 1

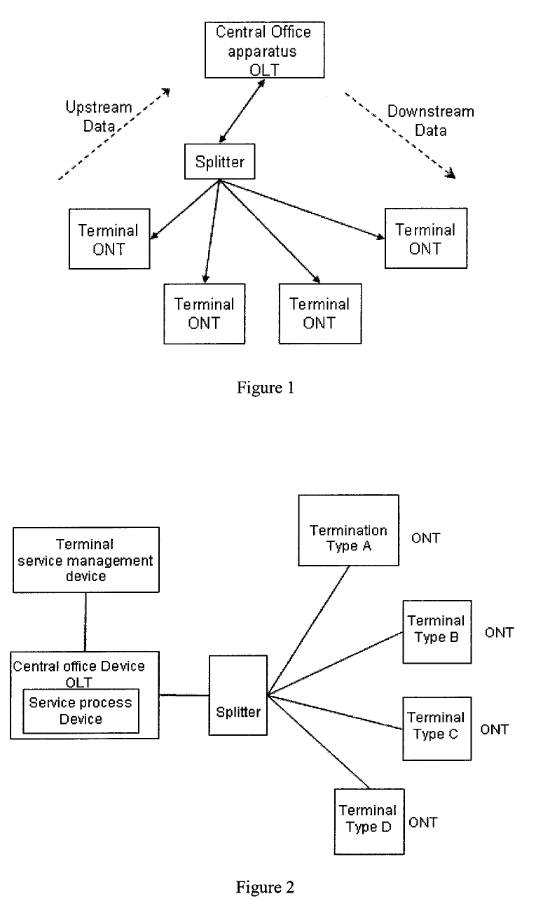

As shown in FIG. 2, the terminal service management apparatus is added to the present PON. The terminal service management apparatus is involved in:

1. Gathering and storing various terminal apparatus ONT information; and

2. Configuring the service classification method for each terminal apparatus.

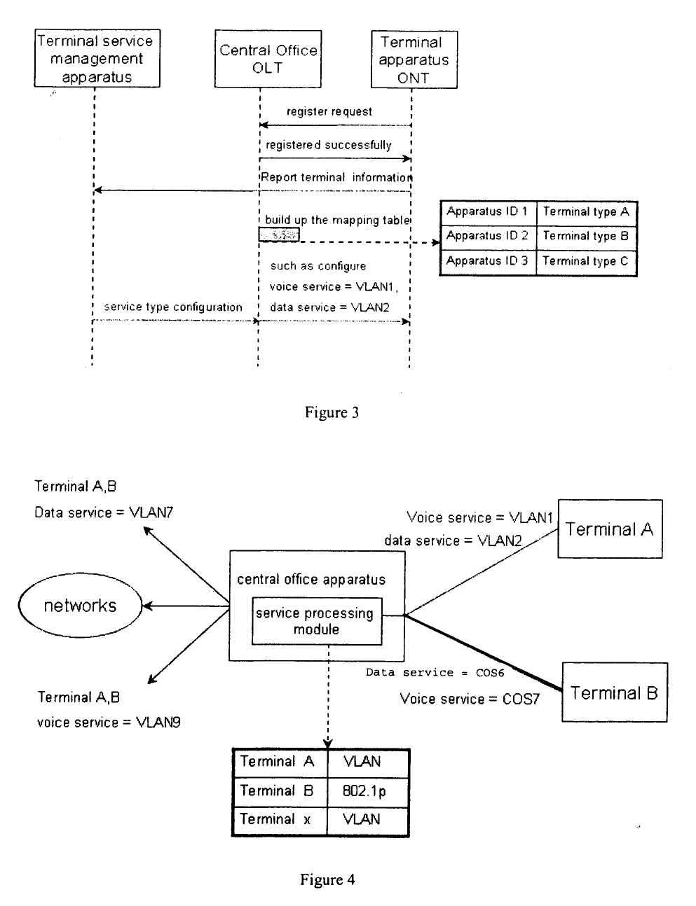

As shown in FIG. 3, when the terminal apparatus ONT is successfully activated and registered to the network, the central office apparatus OLT assigns an apparatus identifier ID. In addition, the terminal apparatus ONT will automatically transmit the manufacturer information, terminal sequence number, terminal type, service classification supported by the terminal, and other terminal attribute information to the terminal service management apparatus through a management information channel build-up between the central office OLT and terminal apparatus ONT. The terminal service management apparatus then queries the inner build-up terminal apparatus processing method table: if there is no relative information for the terminal in the terminal service management apparatus, the transmitted information should be stored into the terminal apparatus processing method table in the terminal service management apparatus; otherwise, the information should be discarded (not shown in the FIG. 3).

After the terminal service management apparatus receives the transmitted information for the registering terminal apparatus, the service configuration information is sent out for the successfully registered terminal apparatus through the management information channel build-up between the central office OLT and the terminal apparatus ONTs using the service classification method supported by the terminal apparatus (such as the VLAN or the 802.1p service classification method).

Referring to FIG. 4, the scheduling procedure for the central office apparatus OLT to execute to different kinds of terminal apparatus ONTs is described in detail below.

When the central office apparatus OLT schedules the upstream data using the bandwidth requirement information transmitted from the various terminal ONTs, the central office apparatus OLT distinguishes the information frames transmitted from the different terminal apparatus ONTs from the received upstream data. The service processing module in the office side apparatus OLT also obtains the terminal apparatus identifier ID assigned by the central office apparatus. The service processing module then finds the corresponding terminal type from the mapping table using the terminal apparatus ID. The terminal service management apparatus determines the processing method for the corresponding terminal apparatus ONT service classification from the terminal apparatus processed method table using the terminal's adopted method type, such as the VLAN method or the 802.1p method. Using the service classification method, the received information frames are processed according to the service classification method. The central office apparatus OLT transmits the processed information frames according to the network side service classification requirements, and uses the common classification strategy to convert the service classification, or nests the service identifier (adds another service classification identifier) to all of the received service information. For example, the service classification processing methods for different terminals, such as VLAN and 802.1p, are switched by the central office apparatus OLT into one having a common classification strategy, such as only the VLAN service classification method, or added another service classification identifier based on the original classification. The information frames are processed by the OLT apparatus and sent to the network connected to the central office apparatus.

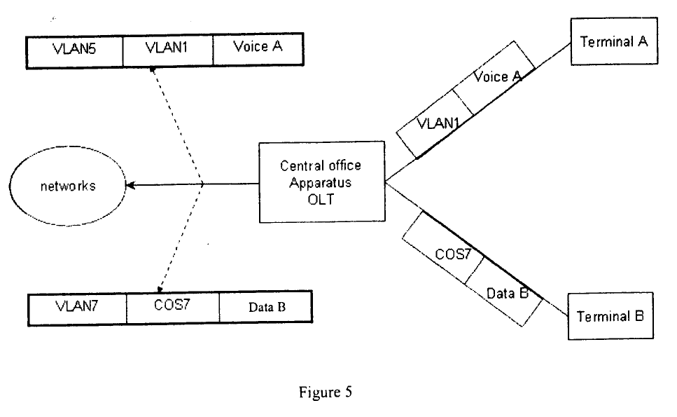

Referring to the FIG. 4 and FIG. 5, the embodiment of the present disclosure is clarified in detail below.

In the central office OLT, the implementation procedure for using a common classification strategy to convert the service identifiers to terminals having different types of service identifiers is as follows.

When network terminal ONT (A) and ONT (B) are activated and registered successfully with the office-side apparatus OLT, the office-side apparatus OLT assigns the terminal identifiers ID(A), ID(B) to the terminals ONT (A) and ONT (B) respectively, and builds up the management information channels to terminals ONT (A) and ONT (B). Network terminals ONT (A) and ONT (B) automatically send the manufacturer information (vendor number), type (a multimedia terminal or a data terminal), service classification method (the service identifier is the VLAN method or the 802.1p COS method) supported by the terminal, and other attribute information (such as the line rate and physical interface) for the network terminals to the terminal service management apparatus through the management information channel build-up between the central office OLT and the terminal apparatus ONTs. The terminal service management apparatus stores and processes the information for the network terminals ONT (A) and ONT (B). At the same time, the terminal service management apparatus configures the service to each network terminal, ONT (A) and ONT (B), through the central office apparatus OLT, using the service classification method supported by the network terminals ONT (A) and ONT (B). If terminal ONT (A) supports the VLAN service classification, the service classification may be configured as voice service=VLAN1 and data service=VLA2. If terminal ONT (B) supports the 802.1p service classification, the service classification should be configured as voice service COS=7 and data service COS=6. Through the service configuration of each network terminal ONT(A) and ONT(B), uniformity of the service classification of network terminals ONT(A) and ONT(B) and the central office apparatus is preserved.

After the service configuration of the network terminals ONT(A) and ONT(B), the central office apparatus OLT adjusts the upstream data of network terminals ONT(A) and ONT(B) respectively according to the bandwidth requirements of network terminals ONT(A) and ONT(B). The network terminals ONT (A) and ONT (B) then transmit their information frames upstream to the central office apparatus OLT using the information frames' position guaranteed by the central office apparatus OLT and the amount of information transmitted.

When the central office apparatus OLT receives the upstream information frames transmitted from the network terminals ONT (A) and ONT (B), the central office apparatus OLT obtains the identifiers ID(A) and ID(B) for the network terminals ONT (A) and ONT (B) respectively. Using the identifiers for the network terminals ONT (A) and ONT (B), the central office apparatus OLT looks up the mapping table and obtains the terminal types for the corresponding network terminals ONT (A) and ONT (B). Using the terminal type for the network terminals ONT (A) and ONT (B), the central office OLT looks up the service classification method supported by the network terminals ONT (A) and ONT (B) in the terminal service management apparatus database. Using the service classification for the network terminals ONT (A) and ONT (B), the central office apparatus OLT classifies the service traffic transmitted from the network terminals ONT(A) and ONT(B), and converts the service identifiers for the network terminals ONT (A) and ONT (B) into the service classification identifiers for the central office apparatus side. Specifically, the data service identifier VLAN2 for ONT (A) is converted into the VLAN7 for the central office OLT side, and the data service identifier COS6 for ONT (B) is converted into the VLAN7 for the central office OLT side. In addition, the voice service identifier VLAN1 for ONT (A) is converted into the VLAN9 for the central office OLT side, and the voice service identifier COS7 for ONT (B) is converted into the VLAN9 for the central office OLT side. The converted information is then stored into the different PRIs for the information queues. For example, the voice service is sent to the high priority queue and the data service is sent to the low priority queue. The processed information frames are then sent into the networks connected to the central office apparatus.

In the central office OLT, the implementation of the nested service identifiers to the terminals identified by the different types of service identifiers is as follows.

The early implementation process is the same as in the first embodiment. The only difference is that the processing method for the terminal service identifiers is distinguished at the central office OLT.

When the central office OLT receives the data streams from the network terminals ONT (A) and ONT (B), the central office OLT nests the network terminals' service stream identifiers into another service identifier. For example, a central office end voice service identifier VLAN5 is added to the voice service identifier for network terminal ONT (A), and a central office end data service identifier VLAN7 is added to the data service identifier for network terminal ONT (B). Then, these nested service traffics are stored into different PRI queues: the voice service is sent to the high priority queue and the data service is sent to the low priority queue. The processed information frames are then sent into the networks connected to the central office apparatus.

Besides an automatically configuration, the relationship mapping table between the terminal apparatus identifier IDs and the terminal type in the central office apparatus can be configured by manual input through the added terminal apparatus.

In an embodiment, the terminal service management and service processing apparatus can be made up of an interconnected apparatus. Indeed, the interconnected apparatus can be realized through other methods and meanwhile the terminal management apparatus and service processing apparatus can be split into even smaller apparatuses.

### Embodiment 2

A service processing module and the mapping table for the terminal apparatus identifier ID and processing method may be added into the central office apparatus. The mapping table may include a two-field terminal apparatus identifier ID and the corresponding processing method for the terminal. The mapping table can be configured manually or automatically (as described in the first embodiment). The service processing module may receive the information frames transmitted from the terminals, get the terminal apparatus identifiers from the information frames, determine the mapping table for the terminal apparatus identifiers and processing methods, and process the information frame using the processing method in the mapping table.

As described above, the embodiments are only some of the implementations of the present disclosure. However, as will be appreciated by those skilled in the art, various modifications may be made to the aforementioned embodiments without departing from the scope of the present disclosure. Therefore, the scope of the present disclosure is in accordance with the scope of the following claims.

1-13. (canceled)

14. A network component comprising a processor configured to implement a method comprising:
receiving a frame from an optical network terminal (ONT); and
obtaining an ONT information from the frame; and
processing the frame with the ONT information.

15. The component of claim 14 wherein the ONT information comprises a service processing information.

16. The component of claim 15 wherein the service processing information comprises a service classification method supported by the ONT.

17. The component of claim 16 wherein the service classification method is obtained from an ONT ID in the frame.

18. The component of claim 17 wherein the method further comprises:
registering the ONT;
assigning an ID to the ONT; and sending the ONT information to a terminal service management unit that configures a table using the ID and an ONT type.

19. The component of claim 14 wherein the ONT information comprises information about an ONT manufacturer, an ONT type, a service classification method supported by the ONT, and an ONT property.

20. The component of claim 19 wherein the method further comprises:
obtaining an ONT ID from the frame;
obtaining the service classification method using the ONT ID; and
processing the frame using the service classification method.

21. The component of claim 20 wherein the method further comprises:
obtaining the ONT type from a mapping table using the ONT ID; and
obtaining a corresponding service classification method using the ONT type.

21. The component of claim 20 wherein processing the frame comprises implementing a service classification conversion or adding a service ID to the frame.

22. A system comprising:
an optical line terminal (OLT);
an interconnecting unit in communication with the OLT, wherein the interconnecting unit is configured to collect an optical network terminal (ONT) information from a plurality of frames received from a plurality of ONTs, the interconnecting unit further to configure a database using the ONT information and process the frames using a frame processing method provided in the database.

23. The system of claim 22 wherein the interconnecting unit comprises:
a terminal service management unit configured to collect the ONT information from the frames, and configure the database using the ONT information; and
a service processing unit configured to process the frames using the frame processing method.

24. The system of claim 23:
wherein the database comprises a first table and a second table; and
wherein the terminal service management unit configures the first table using the ONT information and configures the second table using an ONT ID and an ONT type when the ONT is registered and information about a manufacturer is received, the information about the manufacturer including, a serial number, the ONT type, a service classification method supported by the ONTs, and another ONT property; and
wherein the service processing unit is configured to obtain a processing method corresponding to the frames from the first table and the second table, and process the frames using the processing method when the frames are received.

26. A network component comprising a processor configured to implement a method comprising:
receiving a service from a terminal, wherein the service is configured using a first service classification method;
processing the service such that the service is configured using a second service classification method; and
sending the service to a network that requires the service to be configured using the second service classification method.

27. The component of claim 26 wherein processing the service comprises converting the service such that the service is no longer configured using the first service classification method and is instead configured using the second service classification method.

28. The component of claim 26 wherein processing the service comprises nesting the service such that the first service classification method is nested within the second service classification method.

29. The component of claim 26 wherein the first service classification method and the second service classification method are different classification methods.

30. The component of claim 26 wherein the first service classification method and the second service classification method are the same classification method but have different classification strategies.

31. The component of claim 26 wherein the method further comprises:
assigning an identifier to the terminal; and
storing the identifier and the first service classification method in a database,
wherein upon receipt of the service, the first service classification method is identified using the identifier and the database.

32. The component of claim 26 wherein the method further comprises:
prioritizing the service using a service type; and
placing the service in a queue based on the service type.

33. The component of claim 26 wherein the terminal is an optical network terminal.
